(19) United States
(12) Patent Application Publication
(10) Pub. No.: US 2007/0267915 A1
(43) Pub. Date: Nov. 22, 2007

(54) Vehicle and control method of vehicle

(76) Inventors: Michihito Shimada, Mishima-shi (JP); Shinya Kodama, Susono-shi (JP); Kazuya Maki, Nagoya-shi (JP)

Correspondence Address: KENYON & KENYON LLP, 1500 K STREET N.W., SUITE 700, WASHINGTON, DC, 20005, US

(21) Appl. No.: 11/797,831

(22) Filed: May 8, 2007

(30) Foreign Application Priority Data
May 22, 2006 (JP) 2006-141619

(51) Int. Cl. B60T 8/88

(52) U.S. Cl. 303/122

(57) ABSTRACT

In the case of detection of any abnormality in either of a first braking system and a second braking system of a brake actuator, which causes failed pressurization of brake oil, an electronically-controlled hydraulic braking system is controlled to enable pressurization of the brake oil with a pump included in only a normal braking system, that is, only with a pump of a normal first braking system or only with a pump of a normal second braking system. Such pressurization ensures satisfaction of a braking force demand BF* required by the driver by utilizing an operational pressure or master cylinder pressure Pmc and a pressure increase induced by pressurization of the brake oil by the pump in the normal braking system (step S220 or S230 and step S210).

### BACKGROUND OF THE INVENTION

1. Field of the Invention

The present invention relates to a vehicle and a control method of the vehicle. More specifically the invention pertains to a vehicle equipped with a fluid pressure braking system, as well as to a corresponding control method of such a vehicle.

2. Description of the Related Art

In one known structure of a braking system for a vehicle, a pressure regulator regulates the liquid pressure, which is generated by a liquid pressure generator including an accumulator and a power-driven pump, according to the driver's pressing force of a brake pedal and outputs the regulated liquid pressure. A master cylinder is actuated by a supply of the liquid pressure to an auxiliary liquid pressure chamber. Both the output liquid pressures of the master cylinder and the pressure regulator are supplied to wheel cylinders, so as to apply a braking force to the wheels of the vehicle (see, for example, Japanese Patent Laid-Open Gazette No. 2004-182035). In another known structure of the braking system for the vehicle, a supply of pressure from a high pressure source is regulated by a linear valve, so that the pressure of wheel cylinders provided for specific wheels are controllable, regardless of the driver's braking operation (see, for example, Japanese Patent Laid-Open Gazette No. 2005-41423). In the braking system of the latter structure, when there is some abnormality or failure in the linear valve during control of the vehicle behavior with the supply of pressure from the high pressure source, a connection control valve for controlling the connection between the master cylinder and each wheel cylinder is opened. A target wheel cylinder pressure of each wheel is determined according to only the depression stroke of a brake pedal for a preset time period since the opening of the connection control valve. Such determination prevents an unnecessarily large braking force from being applied to the wheels due to computation of the target wheel cylinder pressure based on the increased master cylinder pressure. The master cylinder pressure is increased by the reverse flow of the high-pressure brake oil from the wheel cylinder to the master cylinder via the open connection control valve. There is also a known braking structure for en electric vehicle, which detects a failure or abnormality in a braking system according to the driver's depression amount of a brake pedal and the hydraulic pressure generated by the driver's braking operation. On detection of any failure or abnormality in the braking system, a drive motor is activated to generate a regenerative braking force corresponding to the driver's depression amount of the brake pedal (see, for example, Japanese Patent Laid-Open Gazette No. 2001-268703).

### SUMMARY OF THE INVENTION

The typical structure of the braking system for the vehicle has a brake actuator having multiple hydraulic systems in a cross arrangement or in an anterior-posterior arrangement. In the braking system of the cross arrangement or the anterior-posterior arrangement, the multiple hydraulic systems of the brake actuator respectively have pumps. The pressure regulation of the brake oil with these pumps changes the distribution of the braking force between left wheels and right wheels or between front wheels and rear wheels and adjust the braking force applied to the respective wheels. When the pressure regulation of the brake oil is disabled by a failure or abnormality occurring in any of the multiple hydraulic systems in the brake actuator, it is impossible to immediately satisfy a braking force demand in response to the driver's braking operation. This may lead to the undesirably long braking time or braking distance.

In a vehicle equipped with a fluid pressure braking structure having multiple braking systems that respectively include a pressurization unit for pressurization of an operation fluid and are related to respective specified wheels among multiple wheels, there is a need of ensuring satisfaction of a braking force demand required by the driver even in the event of some abnormality in pressurization of the operation fluid in any of the multiple braking systems. There is also a need of enhancing the safety during braking control of the vehicle.

In order to attain at least part of the above and the other related objects, the vehicle of the invention and the corresponding control method of the vehicle have the configurations discussed below.

The vehicle of the invention is a vehicle having multiple wheels including: a fluid pressure braking structure including multiple braking systems, the multiple braking systems respectively having a pressurization unit for pressurization of an operation fluid and being related to specified wheels among the multiple wheels, the fluid pressure braking structure capable of making the multiple braking systems output a braking force by utilizing an operational pressure of the operation fluid produced by a driver's braking operation and a pressure increase induced by pressurization of the operation fluid by the respective pressurization units; an abnormality detection module that detects an abnormality in any of the multiple braking systems, the abnormality causing failed pressurization of the operation fluid by the pressurization unit; and a braking control module that controls the fluid pressure braking structure to enable pressurization of the operation fluid by the respective pressurization units of the multiple braking systems and to ensure satisfaction of a braking force demand required by the driver's braking operation in the case of detection of no abnormality in the multiple braking systems by the abnormality detection module when ensuring the braking force demand by utilizing the operational pressure and the pressure increase by the pressurization units, the braking control module controlling the fluid pressure braking structure to enable pressurization of the operation fluid by the pressurization unit of only a normal braking system among the multiple braking systems and to ensure satisfaction of the braking force demand in the case of detection of an abnormality in any of the multiple braking systems by the abnormality detection module when ensuring the braking force demand by utilizing the operational pressure and the pressure increase by the pressurization units.

The vehicle of the invention has the fluid pressure braking structure including the multiple braking systems, which respectively have the pressurization unit for pressurization of the operation fluid and are related to the respective specified wheels among the multiple wheels. The braking force is output from the multiple braking systems of the fluid pressure braking structure by utilizing the operational pressure of the operation fluid produced by the driver's braking operation and the pressure increase induced by pressurization of the operation fluid by the respective pressurization units. In the case of no detection of any abnormity in the multiple braking systems that causes failed pressurization of the operation fluid by the pressurization unit, the fluid pressure braking structure is controlled to enable pressurization of the operation fluid by the respective pressurization units of the multiple braking systems and to ensure satisfaction of the braking force demand, which is required by the driver's braking operation, based on the operational pressure and the pressure increase by the respective pressurization units of the multiple braking system. In the case of detection of an abnormality in any of the multiple braking systems, on the other hand, the fluid pressure braking structure is controlled to enable pressurization of the operation fluid by the pressurization unit of only the normal braking system among the multiple braking systems and to ensure satisfaction of the braking force demand based on the operational pressure and the pressure increase by the pressurization unit of only the normal braking system. Even in the event of a failure or abnormality in any of the multiple braking systems to cause failed pressurization of the operation fluid, the vehicle of the invention ensures satisfaction of the braking force demand required by the driver by utilizing the operational pressure and the pressure increase by the pressurization unit of each normal braking system and to enhance the safety during braking control.

In the vehicle of the invention, wherein the braking control module may control the fluid pressure braking structure to enhance the pressure increase by the pressurization unit of the normal braking system to a certain extent for compensating for a pressure increase expected to be attained by the pressurization unit of an abnormal braking system and to ensure satisfaction of the braking force demand in the case of detection of an abnormality in any of the multiple braking systems when ensuring the braking force demand by utilizing the operational pressure and the pressure increase by the pressurization units.

The vehicle of the invention may further include: a motor that is driven to output at least a regenerative braking force; an accumulator unit that inputs and outputs electric power from and to the motor; a braking force demand setting module that sets a braking force demand required by the driver, in response to the driver's braking operation; and a pressurization command value setting module that sets a pressurization command value for the pressurization unit of each normal braking system, based on the set braking force demand, the regenerative braking force output from the motor, an operational braking force based on the operational pressure, and a result of the abnormality detection by the abnormality detection module, wherein the braking control module may control the motor and the fluid pressure braking structure to actuate the pressurization unit of each normal braking system with the set pressurization command value and to ensure satisfaction of the set braking force demand. In the vehicle equipped with the motor for outputting the regenerative braking force, the pressure increase-based braking force by each pressurization unit may be used to compensate for an insufficiency of the operational pressure-based operational braking force and the regenerative braking force generated by the motor. Even in the event of failed pressurization of the operation fluid by any failure or abnormality in any of the multiple braking systems, this aspect of the invention ensures satisfaction of the braking force demand.

The vehicle of the invention may further include: an operational pressure measurement unit that measures the operational pressure of the operation fluid produced by the driver's braking operation; and a regenerative braking force setting module that sets a regenerative braking force generated by regeneration of the motor, in response to the driver's braking operation, wherein the pressurization command value setting module may set the pressurization command value for the pressurization unit of each normal braking system, based on a result of subtraction of the set regenerative braking force and an operational braking force based on the measured operational pressure from the set braking force demand, as well as based on the result of the abnormality detection by the abnormality detection module. This aspect of the invention enables adequate setting of the pressurization command value for each pressurization unit.

In the vehicle of the invention, wherein the regenerative braking force setting module may set the regenerative braking force generated by regeneration of the motor, in response to the driver's braking operation based on a rotation speed of the motor and a state of charge of the accumulator unit.

The vehicle of the invention may further include: an operational pressure generation unit that pressurizes the operation fluid in response to the driver's braking operation and thereby generates the operational pressure, wherein the pressurization unit included in each of the multiple braking systems may have a pump that is actuated to apply an additional pressure to the operation fluid fed from the operational pressure generation unit, and a pressure difference adjustment unit that functions to adjust a pressure difference between inlet and an outlet of the pump, and the abnormality detection module may detect an abnormality in at least either of the pump and the pressure difference adjustment unit in each of the multiple braking systems.

The present invention is directed to a control method of a vehicle, the vehicle having: multiple wheels; and a fluid pressure braking structure including multiple braking systems, the multiple braking systems respectively having a pressurization unit for pressurization of an operation fluid and being related to specified wheels among the multiple wheels, the fluid pressure braking structure capable of making the multiple braking systems output a braking force by utilizing an operational pressure of the operation fluid produced by a driver's braking operation and a pressure increase induced by pressurization of the operation fluid by the respective pressurization units, the control method including the steps of: (a) detecting an abnormality in any of the multiple braking systems, the abnormality causes failed pressurization of the operation fluid by the pressurization unit; and (b) controlling the fluid pressure braking structure to enable pressurization of the operation fluid by the respective pressurization units of the multiple braking systems and to ensure satisfaction of a braking force demand required by the driver's braking operation in the case of detection of no abnormality in the multiple braking systems in the step (a) when ensuring the braking force demand by utilizing the operational pressure and the pressure increase by the pressurization units, and controlling the fluid pressure braking structure to enable pressurization of the operation fluid by the pressurization unit of only a normal braking system among the multiple braking systems and to ensure satisfaction of the braking force demand in the case of detection of an abnormality in any of the multiple braking systems in the step (a) when ensuring the braking force demand by utilizing the operational pressure and the pressure increase by the pressurization units.

Even in the event of a failure or abnormality in any of the multiple braking systems to cause failed pressurization of the operation fluid, the control method of the vehicle of the invention ensures satisfaction of the braking force demand required by the driver by utilizing the operational pressure and the pressure increase by the pressurization unit of each normal braking system.

In the control method of the vehicle of the invention, wherein the step (b) may control the fluid pressure braking structure to enhance the pressure increase by the pressurization unit of the normal braking system to a certain extent for compensating for a pressure increase expected to be attained by the pressurization unit of an abnormal braking system and to ensure satisfaction of the braking force demand in the case of detection of an abnormality in any of the multiple braking systems when ensuring the braking force demand by utilizing the operational pressure and the pressure increase by the pressurization units.

In the control method of the vehicle of the invention, wherein the vehicle may further include: a motor that is driven to output at least a regenerative braking force; and an accumulator unit that inputs and outputs electric power from and to the motor, the control method may further include the step of: (c) setting a pressurization command value for the pressurization unit of each normal braking system, based on the braking force demand, the regenerative braking force output from the motor, an operational braking force based on the operational pressure, and a result of the abnormality detection in the step (a), wherein the step (b) may control the motor and the fluid pressure braking structure to actuate the pressurization unit of each normal braking system with the pressurization command value set in the step (c) and to ensure satisfaction of the braking force demand.

In the control method of the vehicle of the invention, wherein the vehicle may further include: an operational pressure measurement unit that measures the operational pressure of the operation fluid produced by the driver's braking operation, the control method may further include the step of: (d) setting a regenerative braking force generated by regeneration of the motor, in response to the driver's braking operation, the step (c) may set the pressurization command value for the pressurization unit of each normal braking system, based on a result of subtraction of the regenerative braking force set in the step (d) and an operational braking force based on the measured operational pressure from the braking force demand, as well as based on the result of the abnormality detection in the step (a).

In the control method of the vehicle of the invention, wherein the step (d) may set the regenerative braking force generated by regeneration of the motor, in response to the driver's braking operation based on a rotation speed of the motor and a state of charge of the accumulator unit.

In the control method of the vehicle of the invention, wherein the vehicle may further include: an operational pressure generation unit that pressurizes the operation fluid in response to the driver's braking operation and thereby generates the operational pressure, wherein the pressurization unit included in each of the multiple braking systems may have a pump that is actuated to apply an additional pressure to the operation fluid fed from the operational pressure generation unit, and a pressure difference adjustment unit that functions to adjust a pressure difference between inlet and an outlet of the pump, and wherein the step (a) may detect an abnormality in at least either of the pump and the pressure difference adjustment unit in each of the multiple braking systems.

### BRIEF DESCRIPTION OF THE DRAWINGS

FIG. 1 schematically illustrates the configuration of a hybrid vehicle in one embodiment of the invention;

FIG. 2 is a system diagram of a brake actuator included in an electronically controlled hydraulic braking system mounted on the hybrid vehicle of the embodiment;

FIG. 3 is a flowchart showing an abnormality detection routine executed by a brake ECU in the hybrid vehicle of the embodiment;

FIG. 4 is a flowchart showing a braking control routine executed by the brake ECU in the hybrid vehicle of the embodiment;

FIG. 5 shows one example of a regenerative braking force computation map;

FIG. 6 shows one example of a pedal force setting map; and

FIG. 7 shows one example of a braking force demand setting map.

### DESCRIPTION OF THE PREFERRED EMBODIMENTS

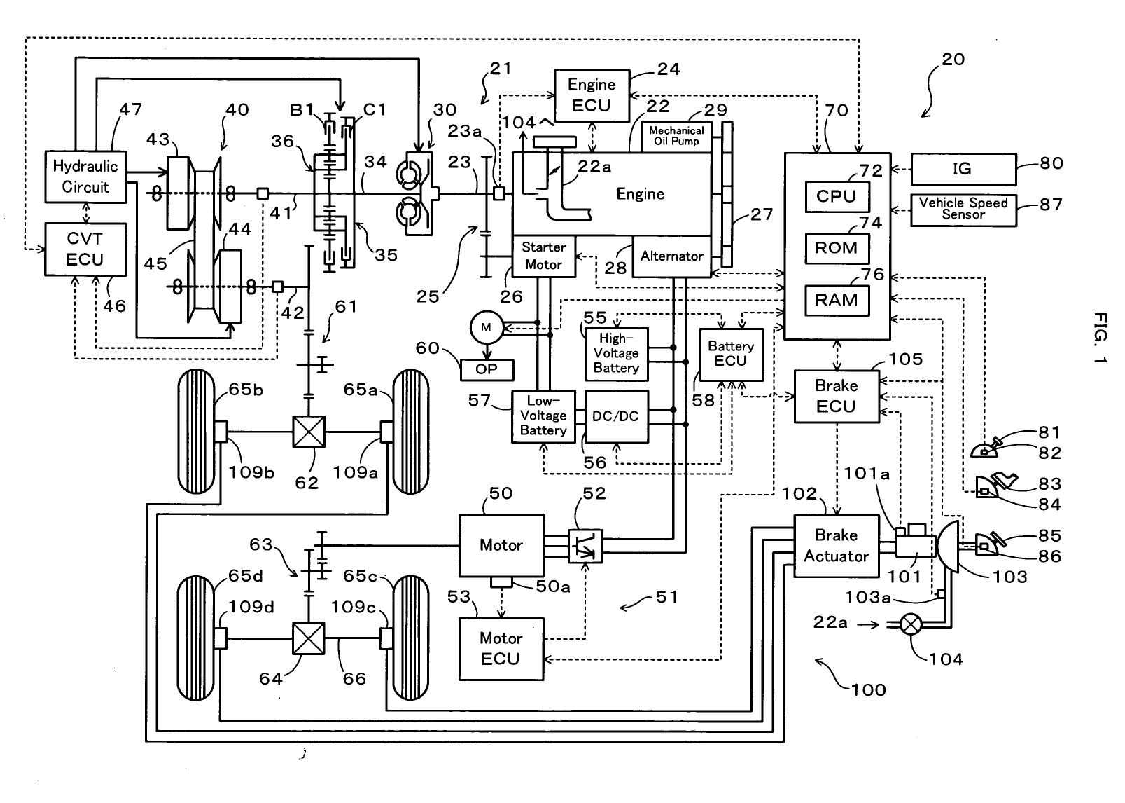

One mode of carrying out the invention is described below as a preferred embodiment. FIG. 1 schematically illustrates the configuration of a hybrid vehicle 20 in one embodiment of the invention. The hybrid vehicle 20 of the embodiment has a front wheel driving system 21 for transmission of output power of an engine 22 to front wheels 65a and 65b via a torque converter 30, a forward-backward drive switchover mechanism 35, a belt-driven continuously variable transmission (hereafter referred to as ‘CVT’) 40, a gear mechanism 61, and a differential gear 62, a rear wheel driving system 51 for transmission of output power of a motor 50 to rear wheels 65c and 65d via a gear mechanism 63, a differential gear 64, and a rear axle 66, an electronically controlled hydraulic braking system (hereafter referred to as ‘HBS’) 100 for application of braking force to the front wheels 65a and 65b and to the rear wheels 65c and 65d, and a hybrid electronic control unit (hereafter referred to as ‘hybrid ECU’) 70 for controlling the operations of the whole hybrid vehicle 20.

The engine 22 is an internal combustion engine that consumes a hydrocarbon fuel, such as gasoline or light oil, to output the power. A crankshaft 23 as an output shaft of the engine 22 is linked to the torque converter 30. The crankshaft 23 is also connected with a starter motor 26 via a gear train 25 and with an alternator 28 and a mechanical oil pump 29 via a belt 27. The engine 22 is driven and operated under control of an engine electronic control unit (hereafter referred to as ‘engine ECU’) 24. The engine ECU 24 receives input signals from various sensors measuring and detecting the operation conditions of the engine 22, for example, a crank position signal from a crank position sensor 23a attached to the crankshaft 23. The engine ECU 24 regulates the amount of fuel injection and the amount of intake air and adjusts the ignition timing, in response to these input signals. The engine ECU 24 makes communication with the hybrid ECU 70 to control the operation of the engine 22 in response to control signals from the hybrid ECU 70 and to output data regarding the operating conditions of the engine 22 to the hybrid ECU 70 according to the requirements.

The torque converter 30 of this embodiment is a known fluid torque converter and is equipped with a hydraulic pressure lockup clutch. The forward-backward drive switchover mechanism 35 includes a double-pinion planetary gear mechanism 36, a brake B1, and a clutch C1. In the forward-backward drive switchover mechanism 35, in the off position of the brake B1 and the on position of the clutch C1, the rotation of the output shaft 34 of the torque converter 30 is directly transmitted to the input shaft 41 of the CVT 40 to move the hybrid vehicle 20 forward. In the on position of the brake B1 and the off position of the clutch C1, the rotation of the output shaft 34 of the torque converter 30 is inverted to the reverse direction and is transmitted to the input shaft 41 of the CVT 40 to move the hybrid vehicle 20 backward. In the off positions of both the brake B1 and the clutch C1, the output shaft 34 of the torque converter 30 is decoupled from the input shaft 41 of the CVT 40.

The CVT 40 includes a primary pulley 43 of variable groove width linked to the input shaft 41, a secondary pulley 44 of variable groove width linked to an output shaft 42 or a driveshaft, and a belt 45 set in the grooves of the primary pulley 43 and the secondary pulley 44. The groove widths of the primary pulley 43 and the secondary pulley 44 are varied by means of the hydraulic pressure of the hydraulic oil applied by a hydraulic circuit 47 under operation control of a CVT electronic control unit (hereafter referred to as CVTECU) 46. Varying the groove widths enables the input power of the input shaft 41 to go through the continuously variable speed change and to be output to the output shaft 42. The hydraulic circuit 47 regulates the hydraulic pressure and the flow rate of the hydraulic oil fed by an electric oil pump 60 and by the mechanical oil pump 29 and supplies the hydraulic oil of the regulated hydraulic pressure and flow rate to the primary pulley 43, the secondary pulley 44, the torque converter 30 (lockup clutch), the brake B1, and the clutch C1. The CVTECU 46 inputs a rotation speed Nin of the input shaft 41 and a rotation speed Nout of the output shaft 42. The CVTECU 46 generates and outputs driving signals to the hydraulic circuit 47, in response to these input data. The CVTECU 46 also controls on and off the brake B1 and the clutch C1 of the forward-backward drive switchover mechanism 35 and performs the lockup control of the torque converter 30. The CVTECU 46 makes communication with the hybrid ECU 70 to regulate the change gear ratio of the CVT 40 in response to control signals from the hybrid ECU 70 and to output data regarding the operating conditions of the CVT 40 to the hybrid ECU 70 according to the requirements.

The motor 50 is constructed as a known synchronous motor generator that may be actuated both as a generator and as a motor. The motor 50 is connected with the alternator 28, which is driven by the engine 22, via an inverter 52 and with a high-voltage battery 55 (for example, a secondary battery having a rated voltage of 42 V) having its output terminal linked to a power line from the alternator 28. The motor 50 is accordingly driven with electric power supplied from the alternator 28 or from the high-voltage battery 55 and generates regenerative electric power during deceleration to charge the high-voltage battery 55. The motor 50 is driven and operated under control of a motor electronic control unit (hereafter referred to as ‘motor ECU’) 53. The motor ECU 53 receives input signals required for the operation control of the motor 50, for example, signals from a rotational position detection sensor 50a that detects the rotational position of a rotor in the motor 50 and values of phase current for the motor 50 from a current sensor (not shown). The motor ECU 53 generates and outputs switching signals to switching elements included in the inverter 52, in response to these input signals. The motor ECU 53 makes communication with the hybrid ECU 70 to output switching control signals to the inverter 52 for the operation control of the motor 50 in response to control signals from the hybrid ECU 70 and to output data regarding the operating conditions of the motor 50 to the hybrid ECU 70 according to the requirements. The high-voltage battery 55 is connected with a low-voltage battery 57 via a DC-DC converter 56 having the function of voltage conversion. The electric power supplied from the high-voltage battery 55 goes through the voltage conversion by the DC-DC converter 56 and is transmitted to the low-voltage battery 57. The low-voltage battery 57 is used as the power source of various auxiliary machines including the electric oil pump 60. Both the high-voltage battery 55 and the low-voltage battery 57 are under management and control of a battery electronic control unit (hereafter referred to as ‘battery ECU’) 58. The battery ECU 58 computes remaining charge levels or states of charge (SOC) and input and output limits of the high-voltage battery 55 and the low-voltage battery 57, based on inter-terminal voltages from voltage sensors (not shown) attached to the respective output terminals (not shown) of the high-voltage battery 55 and the low-voltage battery 57, charge-discharge electric currents from current sensors (not shown), and battery temperatures from temperature sensors (not shown). The battery ECU 58 makes communication with the hybrid ECU 70 to output data regarding the conditions of the high-voltage battery 55 and the low-voltage battery 57, for example, their states of charge (SOC), to the hybrid ECU 70 according to the requirements.

The HBS 100 mounted on the hybrid vehicle 20 has a so-called tandem master cylinder 101, a brake actuator 102, and wheel cylinders 109a through 109d respectively provided for the front wheels 65a and 65b and the rear wheels 65c and 65d. The HBS 100 supplies a master cylinder pressure Pmc to the wheel cylinders 109a through 109d for the front wheels 65a and 65b and the rear wheels 65c and 65d via the brake actuator 102, so as to apply master cylinder pressure Pmc-based braking force to the front wheels 65a and 65b and the rear wheels 65c and 65d. The master cylinder pressure Pmc is generated by the master cylinder 101 as an operation pressure in response to the driver's depression of a brake pedal 85. In the HBS 100 of this embodiment, the master cylinder 101 is provided with a brake booster 103 that utilizes a negative pressure Pn produced by the engine 22 to assist the driver's braking operation. As shown in FIG. 1, the brake booster 103 is connected to an intake manifold 22a of the engine 22 via piping and a check valve 104 and works as a vacuum power-boosting device. The brake booster 103 utilizes the force applied to a diaphragm (not shown) due to a differential pressure between the outside air pressure and the negative intake pressure of the engine 22 and amplifies the driver's pressing force of the brake pedal 85. A piston (not shown) in the master cylinder 101 receives the driver's pressing force of the brake pedal 85 and the assist of negative pressure in the brake booster 103 and pressurizes the brake oil. The master cylinder 101 accordingly generates the master cylinder pressure Pmc corresponding to the driver's pressing force of the brake pedal 85 and the negative pressure Pn of the engine 22.

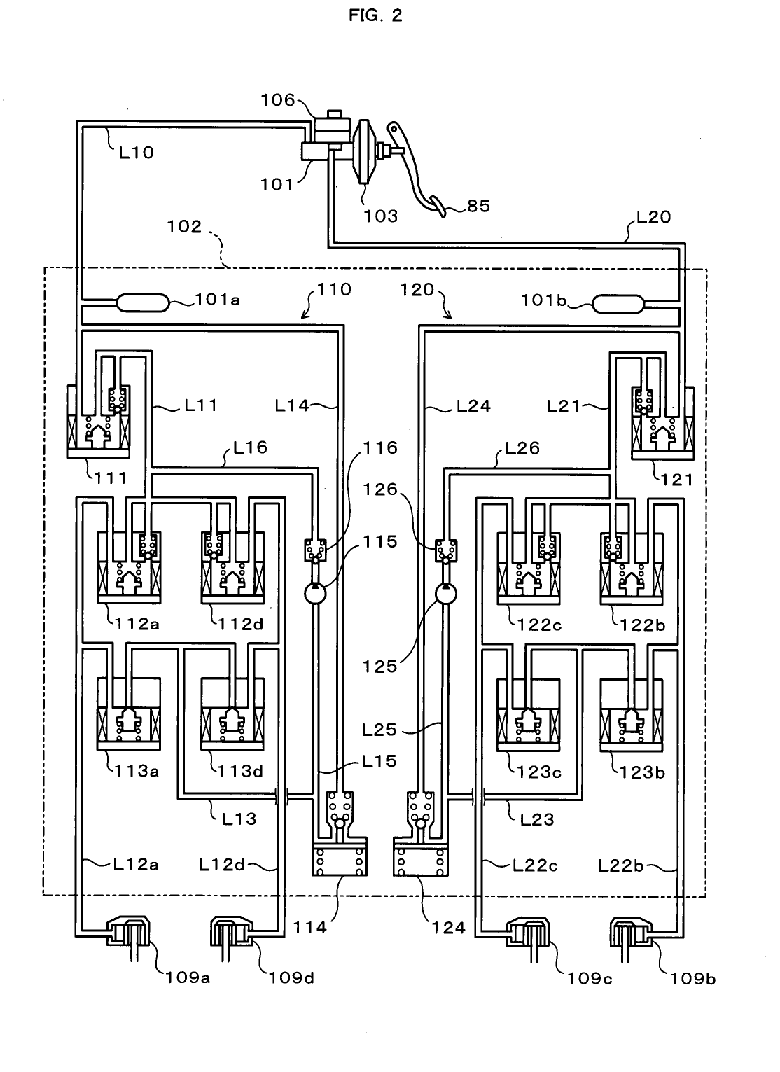

The brake actuator 102 is actuated by the low-voltage battery 57 as the power source. The brake actuator 102 regulates the master cylinder pressure Pmc generated by the master cylinder 101 and supplies the regulated master cylinder pressure Pmc to the wheel cylinders 109a through 109d, while adjusting the hydraulic pressure in the wheel cylinders 109a through 109d to ensure application of braking force to the front wheels 65a and 65b and the rear wheels 65c and 65d regardless of the driver's pressing force of the brake pedal 85. FIG. 2 is a system diagram showing the structure of the brake actuator 102. As shown in FIG. 2, the brake actuator 102 is constructed in cross arrangement and has a first system 110 for the right front wheel 65a and the left rear wheel 65d and a second system 120 for the left front wheel 65b and the right rear wheel 65c. In the hybrid vehicle 20 of this embodiment, the engine 22 for driving the front wheels 65a and 65b is placed in the front portion of the vehicle body to give the front-deviated weight balance. The brake actuator 102 of the cross arrangement ensures application of braking force to at least one of the front wheels 65a and 65b even in the event of some failure in either the first system 110 or the second system 120. In this embodiment, the specification of the brake actuator 102 is determined to ensure application of the greater braking force to the front wheels 65a and 65b than the braking force applied to the rear wheels 65c and 65d, when the hydraulic pressure (wheel cylinder pressure) in the wheel cylinders 109a and 109b for the front wheels 65a and 65b is equal to the hydraulic pressure (wheel cylinder pressure) in the wheel cylinders 109c and 109d for the rear wheels 65c and 65d. The specification of the brake actuator 102 includes the friction coefficient of brake pads and the outer diameter of rotors in friction brake units, for example, disk brakes or drum brakes, which receive the hydraulic pressure from the wheel cylinders 109a through 109d to generate frictional braking force.

The first system 110 includes a master cylinder cut solenoid valve (hereafter referred to as ‘MC cut solenoid valve’) 111 connected with the master cylinder 101 via an oil supply path L10, and holding solenoid valves 112a and 112d linked to the MC cut solenoid valve 111 via an oil supply path L11 and respectively connected with the wheel cylinder 109a for the right front wheel 65a and with the wheel cylinder 109d for the left rear wheel 65d via pressure-varying oil paths L12a and L12d. The first system 110 also includes pressure reduction solenoid valves 113a and 113d respectively connected with the wheel cylinder 109a for the right front wheel 65a and with the wheel cylinder 109d for the left rear wheel 65d via the pressure-varying oil paths L12a and L12d, a reservoir 114 linked to the pressure reduction solenoid valves 113a and 113d via a pressure reduction oil path L13 and to the oil supply path L10 via an oil path L14, and a pump 115 having an inlet connected to the reservoir 114 via an oil path L15 and an outlet connected to the oil supply path L11 via an oil path L16 with a check valve 116. Similarly the second system 120 includes an MC cut solenoid valve 121 connected with the master cylinder 101 via an oil supply path L20, and holding solenoid valves 122b and 122c linked to the MC cut solenoid valve 121 via an oil supply path L21 and respectively connected with the wheel cylinder 109b for the left front wheel 65b and with the wheel cylinder 109c for the right rear wheel 65c via pressure-varying oil paths L22b and L22c. The second system 120 also includes pressure reduction solenoid valves 123b and 123c respectively connected with the wheel cylinder 109b for the left front wheel 65b and with the wheel cylinder 109c for the right rear wheel 65c via the pressure-varying oil paths L22b and L22c, a reservoir 124 linked to the pressure reduction solenoid valves 123b and 123c via a pressure reduction oil path L23 and to the oil supply path L20 via an oil path L24, and a pump 125 having an inlet connected to the reservoir 124 via an oil path L25 and an outlet connected to the oil supply path L21 via an oil path L26 with a check valve 126.

The MC cut solenoid valve 111, the holding solenoid valves 112a and 112d, the pressure reduction solenoid valves 113a and 113d, the reservoir 114, the pump 115, and the check valve 116 included in the first system 110 respectively correspond to and are identical with the MC cut solenoid valve 121, the holding solenoid valves 122b and 122c, the pressure reduction solenoid valves 123b and 123c, the reservoir 124, the pump 125, and the check valve 126 included in the second system 120. Each of the MC cut solenoid valves 111 and 121 is a linear solenoid valve that is full open in the power cut-off condition (off position) and has the opening adjustable by regulation of the electric current supplied to a solenoid. The MC cut solenoid valve 111 or 121 couples and decouples the master cylinder 101 with and from the wheel cylinders 109a and 109d or with and from the wheel cylinders 109b and 109c and adjusts the differential pressure between the inlet and the outlet of the pump 115 or 125. Each of the holding solenoid valves 112a, 112d, 122b, and 122c is a normally-open solenoid valve that is closed in the power supply condition (on position). Each of the holding solenoid valves 112a, 112d, 122b, and 122c has a check valve activated to return the flow of brake oil to the oil supply path L11 or L21 when the wheel cylinder pressure in the corresponding one of the wheel cylinders 109a through 109d is higher than the hydraulic pressure in the oil supply path L11 or L21 in the closed position of the holding solenoid valve 112a, 112d, 122b, or 122c under the power supply condition (on position). Each of the pressure reduction solenoid valves 113a, 113d, 123b, and 123c is a normally-closed solenoid valve that is opened in the power supply condition (on position). The pump 115 of the first system 110 and the pump 125 of the second system 120 are actuated by respective non-illustrated drive motors (for example, duty-controlled brushless DC motors). The pump 115 or 125 takes in and pressurizes the brake oil in the corresponding reservoir 114 or 124 and supplies the pressurized brake oil to the oil path L16 or L26.

The brake actuator 102 of the above construction has the operations described below. In the normal off position of all the MC cut solenoid valves 111 and 121, the holding solenoid valves 112a, 112d, 122b, and 122c, and the pressure reduction solenoid valves 113a, 113d, 123b, and 123c (in the state of FIG. 2), in response to the driver's depression of the brake pedal 85, the master cylinder 101 generates the master cylinder pressure Pmc corresponding to the driver's pressing force of the brake pedal 85 and the negative pressure Pn of the engine 22. The brake oil is then supplied to the wheel cylinders 109a through 109d via the oil supply paths L10 and L20, the MC cut solenoid valves 111 and 121, the oil supply paths L11 and L21, the holding solenoid valves 112a, 112d, 122b, and 122c, and the pressure-varying oil paths L12a, L12d, L22b, and L22c. The master cylinder pressure Pmc-based braking force is thus applied to the front wheels 65a and 65b and the rear wheels 65c and 65d. In response to the driver's subsequent release of the brake pedal 85, the brake oil in the wheel cylinders 109a through 109d is returned to a reservoir 106 of the master cylinder 101 via the pressure-varying oil paths L12a, L12d, L22b, and L22c, the holding solenoid valves 112a, 112d, 122b, and 122c, the oil supply paths L11 and L21, the MC cut solenoid valves 111 and 121, and the oil supply paths L10 and L20. This decreases the hydraulic pressure in the wheel cylinders 109a through 109d to release the braking force applied to the front wheels 65a and 65b and the rear wheels 65c and 65d. During application of the braking force to the front wheels 65a and 65b and the rear wheels 65c and 65d, the power supply to close the holding solenoid valves 112a, 112d, 122b, and 122c (on position) keeps the hydraulic pressure in the wheel cylinders 109a through 109d. The power supply to open the pressure reduction solenoid valves 113a, 113d, 123b, and 123c (on position) introduces the brake oil in the wheel cylinders 109a through 109d to the reservoirs 114 and 124 via the pressure-varying oil paths L12a, L12d, L22b, and L22c, the pressure reduction solenoid valves 113a, 113d, 123b, and 123c, and the pressure reduction oil paths L13 and L23 to reduce the wheel cylinder pressure in the wheel cylinders 109a through 109d. The brake actuator 102 accordingly attains antilock braking (ABS) control to prevent a skid of the hybrid vehicle 20 due to the lock of any of the front wheels 65a and 65b and the rear wheels 65c and 65d in response to the driver's depression of the brake pedal 85.

On the driver's depression of the brake pedal 85, the brake actuator 102 actuates the pumps 115 and 125 with reduction of the openings of the MC cut solenoid valves 111 and 121 to introduce the brake oil from the master cylinder 101 to the reservoirs 114 and 124. The brake oil introduced from the master cylinder 101 to the reservoirs 114 and 124 has the pressure increased by the pumps 115 and 125 and is fed to the wheel cylinders 109a through 109d via the oil paths L16 and L26, the holding solenoid valves 112a, 112d, 122b, and 122c, and the pressure-varying oil paths L12a, L12d, L22b, and L22c. Actuation of the pumps 115 and 125 simultaneously with the opening adjustment of the MC cut solenoid valves 111 and 121 attains the braking assist and gives the braking force as the sum of the master cylinder pressure Pmc and the pressure increase by the pumps 115 and 125. Even in the state of the driver's release of the brake pedal 85, actuation of the pumps 115 and 125 simultaneously with the opening adjustment of the MC cut solenoid valves 111 and 121 enables the brake oil introduced from the reservoir 106 of the master cylinder 101 to the reservoirs 114 and 124 of the brake actuator 102 to be pressurized by the pumps 115 and 125 and to be fed to the wheel cylinders 109a through 109d. The individual on-off control of the holding solenoid valves 112a, 112d, 122b, and 122c and the pressure reduction solenoid valves 113a, 113d, 123b, and 123c individually and freely regulates the pressure in each of the wheel cylinders 109a through 109d. The brake actuator 102 thus attains traction control (TRC) to prevent a skid of the hybrid vehicle 20 due to the wheelspin of any of the front wheels 65a and 65b and the rear wheels 65c and 65d in response to the driver's depression of the brake pedal 85. The brake actuator 102 also attains attitude stabilization control (VSC) to prevent a sideslip of any of the front wheels 65a and 65b and the rear wheels 65c and 65d, for example, during a turn of the hybrid vehicle 20.

The brake actuator 102 is driven and operated under control of a brake electronic control unit (hereafter referred to as ‘brake ECU’) 105. More specifically the brake ECU 105 controls the operations of the MC cut solenoid valves 111 and 121, the holding solenoid valves 112a, 112d, 122b, and 122c, the pressure reduction solenoid valves 113a, 113d, 123b, and 123c, and each motor for actuating the pumps 115 and 125. The brake ECU 105 inputs the master cylinder pressure Pmc generated by the master cylinder 101 and measured by a master cylinder pressure sensor 101a, a negative pressure Pn in the brake booster 103 produced by the engine 22 and measured by a pressure sensor 103a, a signal from a pedal force detection switch 86 attached to the brake pedal 85 and mainly used in the event of a failure of the brake actuator 102, wheel speeds from respective wheel speed sensors (not shown) placed on the front wheels 65a and 65b and the rear wheels 65c and 65d, and a steering angle from a steering angle sensor (not shown). The brake ECU 105 makes communication with the hybrid ECU 70, the motor ECU 53, and the battery ECU 58. The brake ECU 105 controls the operation of the brake actuator 102 according to the input data including the master cylinder pressure Pmc and the negative pressure Pn, the state of charge (SOC) of the high-voltage battery 55, a rotation speed Nm of the motor, and control signals from the hybrid ECU 70, so as to attain the braking assist, the ABS control, the TRC, and the VSC. The brake ECU 105 outputs the operating conditions of the brake actuator 102 to the hybrid ECU 70, the motor ECU 53, and the battery ECU 58 according to the requirements.

The hybrid ECU 70 is constructed as a microprocessor including a CPU 72, a ROM 74 that stores processing programs, a RAM 76 that temporarily stores data, input and output ports (not shown), and a communication port (not shown). The hybrid ECU 70 receives, via its input port, an ignition signal from an ignition switch 80, a gearshift position SP or a current setting position of a gearshift lever 81 from a gearshift position sensor 82, an accelerator opening Acc or the driver's depression amount of an accelerator pedal 83 from an accelerator pedal position sensor 84, a signal from the pedal force detection switch 86, and a vehicle speed V from a vehicle speed sensor 87. The hybrid ECU 70 generates diverse control signals in response to these input signals and transmits control signals and data to and from the engine ECU 24, the CVTECU 46, the motor ECU 53, the battery ECU 58, and the brake ECU 105 by communication. The hybrid ECU 70 outputs, via its output port, for example, driving signals to the starter motor 26 and the alternator 28 linked to the crankshaft 23 and control signals to the electric oil pump 60.

In response to the driver's operation of the accelerator pedal 83, the hybrid vehicle 20 of the embodiment may be driven with the output power of the engine 22 transmitted to the front wheels 65a and 65b, with the output power of the motor 50 transmitted to the rear wheels 65c and 65d, or with both the output power of the engine 22 and the output power of the motor 50 as the four-wheel drive. The hybrid vehicle 20 is driven by the four-wheel drive, for example, in the event of abrupt acceleration by the driver's heavy depression of the accelerator pedal 83 or in the event of a skid or slip of any of the front wheels 65a and 65b and the rear wheels 65c and 65d. When the driver releases the accelerator pedal 83 to give an accelerator off-based speed reduction requirement at the vehicle speed V of not lower than a predetermined level, the hybrid vehicle 20 of the embodiment sets both the brake B1 and the clutch Cl off to decouple the engine 22 from the CVT 40, stops the operation of the engine 22, and performs the regenerative control of the motor 50. The regenerative control of the motor 50 applies the braking force to the rear wheels 65c and 65d to decelerate the hybrid vehicle 20. The regenerative electric power generated by the motor 50 during deceleration may be used to charge the high-voltage battery 55. This arrangement desirably enhances the energy efficiency in the hybrid vehicle 20.

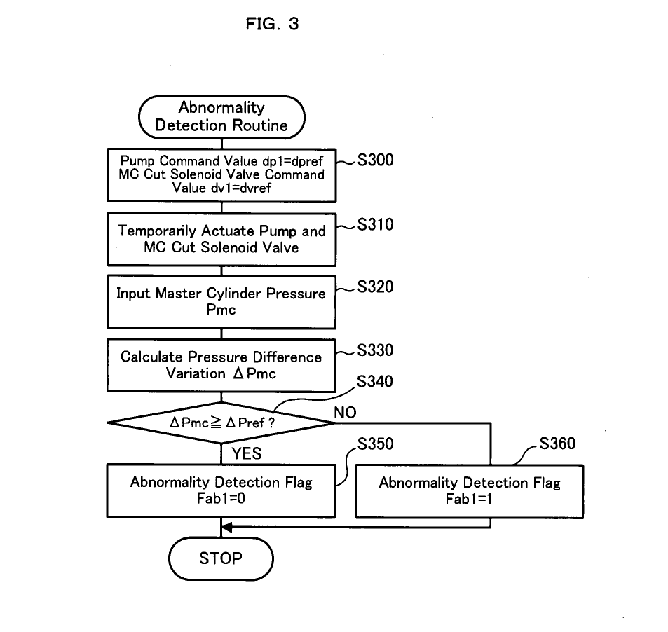

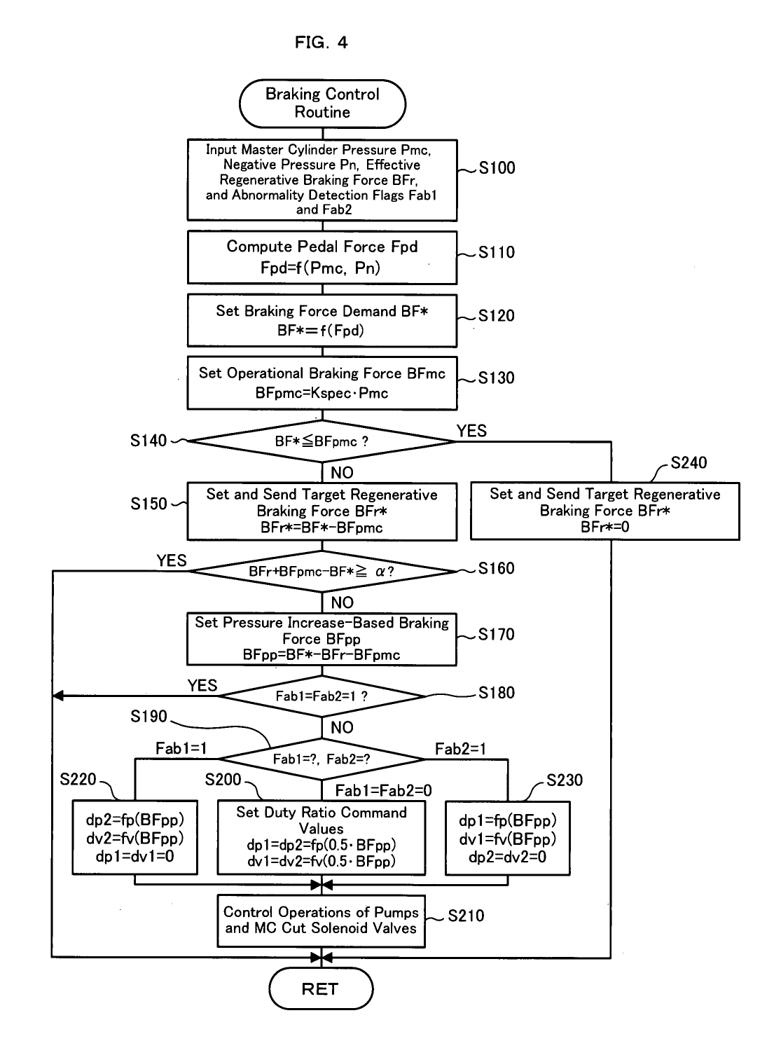

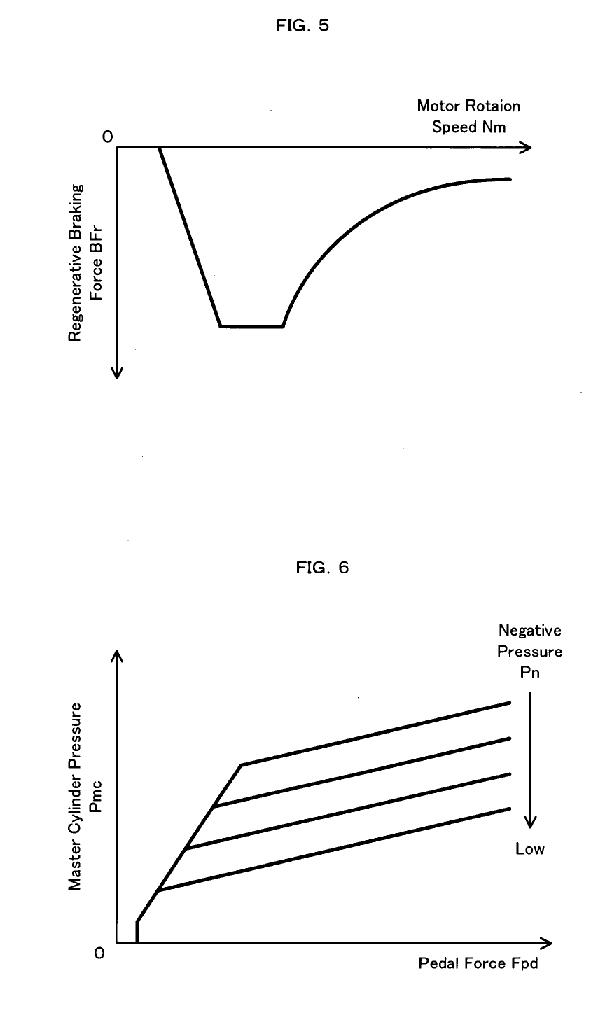

The following describes the operations in the hybrid vehicle 20 of the embodiment having the above configuration, especially a series of braking control in response to the driver's depression of the brake pedal 85. An abnormality detection routine for the brake actuator 102 executed in the hybrid vehicle 20 of the embodiment is described first with reference to the flowchart of FIG. 3. The description then regards a braking control routine executed in the hybrid vehicle 20 of the embodiment with reference to the flowchart of FIG. 4 and the maps of FIGS. 5 through 7.

FIG. 3 is a flowchart showing an abnormality detection routine for the brake actuator 102 executed by the brake ECU 105 in the hybrid vehicle 20 of the embodiment. This abnormality detection routine identifies whether pressurization of the brake oil (brake assist) by the pumps 115 and 125 is normal or abnormal in the first system 110 and the second system 120 of the brake actuator 102. For example, the abnormality detection is performed individually for the first system 110 and for the second system 120 in the ordinary state (the state of FIG. 2) as an initial check immediately after every on-operation of the ignition switch 80. The procedure of abnormality detection for the first system 110 is identical with the procedure of abnormality detection for the second system 120. The following description is thus focused on abnormality detection for the first system 110. The pressurization of the brake oil by the pump 115 or 125 may be abnormal, for example, in the event of a failure of the pump 115 or 125 (or a failure of the corresponding drive motor) or in the abnormal state of the MC cut solenoid valve 111 or 121. When the MC cut solenoid valve 111 or 121 is abnormally kept open to make its opening unadjustable, the brake oil pressurized by the pump 115 or 125 is flowed into the master cylinder 101.

At the execution timing of this abnormality detection routine, a non-illustrated CPU of the brake ECU 105 sets a duty ratio command value dp1 for the motor of the pump 115 to a preset value dpref and a duty ratio command value dv1 for the solenoid of the MC cut solenoid valve 111 to a preset value dvref (step S300). The motor of the pump 115 and the solenoid of the MC cut solenoid valve 111 are driven temporarily with the respective duty ratio command values dp1 (=dpref) and dv1 (=dvref) for a predetermined time period (for example, 3 to 6 msec) and are stopped after elapse of the predetermined time period (step S310). When both the pump 115 and the MC cut solenoid valve 111 temporarily driven for the check are in the normal state, regardless of the driver's depression or release of the brake pedal 85, there is a temporary pressure difference (pulsation) between both sides of the MC cut solenoid valve 111, that is, between the oil supply path L10 and the oil supply path L11. This pressure difference immediately disappears within a very short time period. The master cylinder pressure Pmc is input from the master cylinder pressure sensor 101a for only a preset time period after completion of the temporary actuation and stop at step S310 and is stored in a specific memory area (step S320). A variation in pressure difference αPmc is calculated from the input master cylinder pressure Pmc (step S330).

The calculated pressure difference variation αPmc is compared with a preset reference value ΔPref (step S340). The reference value ΔPref is experimentally and analytically obtained and represents a variation of the pressure difference in the case of temporary actuation of the pump 115 and the MC cut solenoid valve 111 with the respective duty ratio command values dp1 (=dpref) and dv1 (=dvref), on condition that both the pump 115 and the MC cut solenoid valve 111 are normal. When the calculated pressure difference variation αPmc is not less than the preset reference value ΔPref (step S340: yes), both the pump 115 and the MC cut solenoid valve 111 are identified as normal. In this case, an abnormality detection flag Fab1 is set to 0 (step S350). The setting of the abnormality detection flag Fab1 to 0 shows that pressurization of the brake oil by the pump 115 is normally executable in the first system 110 of the brake actuator 102. When the calculated pressure difference variation αPmc is less than the preset reference value ΔPref (step S340: no), on the other hand, there is some abnormality in at least either of the opening adjustment function (differential pressure adjustment function) of the MC cut solenoid valve 111 and the pressurization function of the pump 115. In this case, the abnormality detection flag Fab1 is set to 1 (step S360). The setting of the abnormality detection flag Fab1 to 1 shows that pressurization of the brake oil by the pump 115 is not normally executable in the first system 110 of the brake actuator 102. The abnormality detection routine is similarly executed for the second system 120 using a master cylinder pressure Pmc measured by a master cylinder pressure sensor 101b. When both the pump 125 and the MC cut solenoid valve 121 are identified as normal, an abnormality detection flag Fab2 is set to 0. The setting of the abnormality detection flag Fab2 to 0 shows that pressurization of the brake oil by the pump 125 is normally executable in the second system 120 of the brake actuator 102. When there is any abnormality in at least either of the opening adjustment function of the MC cut solenoid valve 121 and the pressurization function of the pump 125, the abnormality detection flag Fab2 is set to 1. The setting of the abnormality detection flag Fab2 to 1 shows that pressurization of the brake oil by the pump 125 is not normally executable in the second system 120 of the brake actuator 102. In response detection of any abnormality in pressurization of the brake oil by the pump 115 in the first system 110 or by the pump 125 in the second system 120 according to this abnormality detection routine, an alarm lamp on an instrument panel (not shown) is lit on to inform the driver of the abnormality.

The braking control routine executed by the brake ECU 105 in the hybrid vehicle 20 of the embodiment is described below with reference to the flowchart of FIG. 4. The braking control routine of FIG. 4 is repeatedly executed at preset time intervals (for example, at every several msec) during the driver's depression of the brake pedal 85. On the start of the braking control routine shown in FIG. 4, the non-illustrated CPU of the brake ECU 105 inputs required data for control, that is, the master cylinder pressure Pmc from the master cylinder pressure sensor 101a, the negative pressure Pn from the pressure sensor 103a, an effective regenerative braking force BFr generated by regeneration of the motor 50, and the settings of the abnormality detection flags Fab1 and Fab2 (step S100). The effective regenerative braking force BFr is set corresponding to the rotation speed Nm of the motor 50 and the state of charge SOC of the high-voltage battery 55 and is received from the hybrid ECU 70 by communication. In this embodiment, a relation between the effective regenerative braking force BFr and the rotation speed Nm of the motor 50 is specified in advance with regard to each charge level or state of charge SOC of the high-voltage battery 55, based on the rated regenerative torque of the motor 50. The specified relation is stored as a regenerative braking force computation map in the ROM 74 of the hybrid ECU 70. One example of the regenerative braking force computation map is shown in FIG. 5. The hybrid ECU 70 selects a regenerative braking force computation map corresponding to the state of charge SOC of the high-voltage battery 55 input from the battery ECU 58 at every preset time interval and reads the effective regenerative braking force BFr corresponding to the given rotation speed Nm of the motor 50 from the selected regenerative braking force computation map. The effective regenerative braking force BFr input at step S100 is accordingly the value sampled immediately before the input. The abnormality detection flags Fab1 and Fab2 have been set in the abnormality detection routine executed in response to the ON operation of the ignition switch 80 as described above.

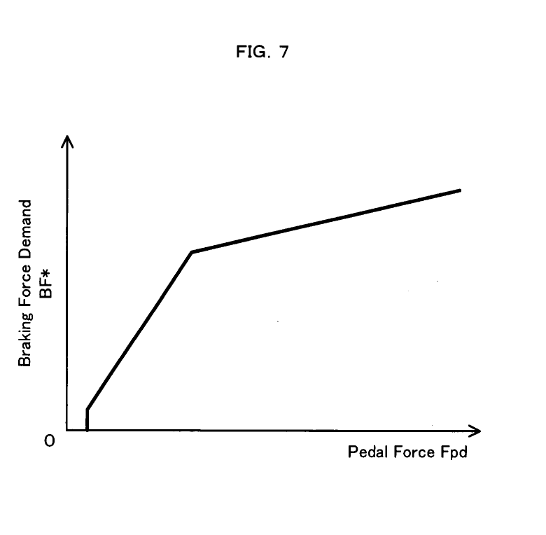

After the data input at step S100, the CPU computes a pedal force Fpd applied by the driver's depression of the brake pedal 85 from the input master cylinder pressure Pmc and the input negative pressure Pn (step S110). The procedure of this embodiment prepares and stores in advance variations in pedal force Fpd against the master cylinder pressure Pmc and the negative pressure Pn as a pedal force setting map in a ROM (not shown) of the brake ECU 105 and reads the pedal force Fpd corresponding to the given master cylinder pressure Pmc and the given negative pressure Pn from the pedal force setting map. FIG. 6 shows one example of the pedal force setting map. The CPU subsequently computes a braking force demand BF* as the driver's requirement from the set pedal force Fpd (step S120). The procedure of this embodiment prepares and stores in advance a variation in braking force demand BF* against the pedal force Fpd as a braking force demand setting map in the ROM of the brake ECU 105 and reads the braking force demand BF* corresponding to the given pedal force Fpd from the braking force demand setting map. FIG. 7 shows one example of the braking force demand setting map. The servo ratio in the brake booster 103 varies with a variation in negative pressure Pn applied from the engine 22 to the brake booster 103. By taking into account this variation, the braking control of this embodiment computes the pedal force Fpd given by the driver's depression of the brake pedal 85 according to the master cylinder pressure Pmc and the negative pressure Pn and sets braking force demand BF* corresponding to the computed pedal force Fpd. This enables accurate setting of the braking force demand BF* corresponding to the driver's requirement even in the event of a variation in negative pressure Pn applied from the engine 22 to the brake booster 103.

The master cylinder pressure Pmc input at step S100 is multiplied by a constant Kspec to set a master cylinder pressure Pmc-based operational braking force BFmc (step S130). The constant Kspec is determined according to the braking specification including the outer diameter of the brake rotors, the diameter of the wheels, the sectional area of the wheel cylinders, and the friction coefficient of the brake pads. The CPU then determines whether the braking force demand BF* computed at step S120 is not greater than the operational braking force BFpmc set at step S130 (step S140). On condition that the braking force demand BF* is not greater than the operational braking force BFpmc, the braking force demand required by the driver can be satisfied by only the master cylinder pressure Pmc-based operational braking force BFpmc. When the braking force demand BF* is not greater than the operational braking force BFpmc (step S140: yes), the CPU sets 0 to a target regenerative braking force BFr*, which is to be produced by regeneration of the motor 50, and sends the setting of the target regenerative braking force BFr* to the motor ECU 53 (step S240). The CPU then exits from this braking control routine. In this state, the master cylinder pressure Pmc-based operational braking force BFpmc is directly transmitted to the front wheels 65a and 65b and to the rear wheels 65c and 65d. The MC cut solenoid valves 111 and 121 are set in the off position to be kept full open.

On condition that the braking force demand BF* is greater than the operational braking force BFpmc, on the other hand, the braking force demand required by the driver can not be satisfied by only the master cylinder pressure Pmc-based operational braking force BFpmc. When the braking force demand BF* is greater than the operational braking force BFpmc (step S140: no), the CPU sets the result of subtraction of the operational braking force BFpmc set at step S130 from the braking force demand BF* computed at step S120 to the target regenerative braking force BFr*, which is to be produced by regeneration of the motor 50, and sends the setting of the target regenerative braking force BFr* to the motor ECU 53 (step S150). The regenerative braking force producible by regeneration of the motor 50 varies according to the rotation speed Nm of the motor 50 (that is, the vehicle speed V) and the state of charge SOC of the high-voltage battery 55. The target regenerative braking force BFr* set and sent at step S150 is not always coverable by the output from the motor 50. Under some conditions, the output of the motor 50 may be less than the target regenerative braking force BFr* and fail to satisfy the braking force demand BF* required by the driver. After sending the setting of the target regenerative braking force BFr* at step S150, the CPU determines whether the result of subtraction of the braking force demand BF* computed at step S120 from the sum of the effective regenerative braking force BFr input at step S100 and the operational braking force BFpmc set at step S130 is not less than a predetermined threshold value a (step S160). The threshold value a is determined experimentally and analytically by taking into account a variation in regenerative braking force during the driver's braking operation and is, for example, a positive value approximate to 0. In the case of an affirmative answer at step S160, the motor 50 is capable of outputting the target regenerative braking force BFr*. Namely the braking force demand BF* is satisfied by the sum of the master cylinder pressure Pmc-based operational braking force BFpmc and the regenerative braking force produced by the motor 50. The CPU then exits from the braking control routine of FIG. 4. The motor ECU 53 receives the target regenerative braking force BFr* and performs switching control of switching elements included in the inverter 52 to enable output of the target regenerative braking force BFr* from the motor 50. In this state, the master cylinder pressure Pmc-based operational braking force BFpmc is directly transmitted to the front wheels 65a and 65b and to the rear wheels 65c and 65d. The MC cut solenoid valves 111 and 121 are set in the off position to be kept full open.

In the case of a negative answer at step S160, on the other hand, the regenerative braking force actually output from the motor 50 is less than the target regenerative braking force BFr*. The output of the motor 50 may thus fail to satisfy the braking force demand BF* required by the driver. When BFr+BFpmc-BF* is less than the predetermined threshold value a (step S160: no), the result of subtraction of the effective regenerative braking force BFr input at step S100 and the operational braking force BFpmc set at step S130 from the braking force demand BF* computed at step S120 is set to a pressure increase-based braking force BFpp, which is based on the pressure increase induced by pressurization of the brake oil by the pumps 115 and 125 (step S170). The pumps 115 and 125 are actuated and controlled to pressurize the brake oil fed from the master cylinder 101 and thereby compensate for a potential insufficiency of braking force. After setting the pressure increase-based braking force BFpp, the CPU determines whether the settings of the abnormality detection flags Fab1 and Fab2 input at step S100 are both equal to 1 (step S180). When both the abnormality detection flags Fab1 and Fab2 are not equal to 1 (step S180: no), the CPU identifies the settings of the abnormality detection flags Fab1 and Fab2 (step S190). When both the abnormality detection flags Fab1 and Fab2 for the first system 110 and the second system 120 are identified as 0 at step S190, the CPU sets the duty ratio command value dp1 of the motor for the pump 115 in the first system 110, the duty ratio command value dv1 for the MC cut solenoid valve 111 in the first system 110, the duty ratio command value dp2 of the motor for the pump 125 in the second system 120, and the duty ratio command value dv2 for the MC cut solenoid valve 121 in the second system 120, based on the pressure increase-based braking force BFpp set at step S170 (step S200). In this embodiment, variations in duty ratio command values dp1 and dp2 for the pumps 115 and 125 against the pressure increase-based braking force BFpp or the pressure increase by the pumps 115 and 125 are specified and stored in advance as a pump command value setting map (not shown) in the ROM of the brake ECU 105. Similarly variations in duty ratio command values dv1 and dv2 for the MC cut solenoid valves 111 and 121 against the pressure increase-based braking force BFpp or the pressure increase by the pumps 115 and 125 are specified and stored in advance as a valve command value setting map (not shown) in the ROM of the brake ECU 105. The first system 110 and the second system 120 are laid out in the cross arrangement in the brake actuator 102 of the embodiment. According to the concrete procedure of this embodiment, the duty ratio command values dp1 and dp2 for the pumps 115 and 125 and the duty ratio command values dv1 and dv2 for the MC cut solenoid valves 111 and 121 are read corresponding to half (½) the pressure increase-based braking force BFpp set at step S170 respectively from the pump command value setting map and from the valve command value setting map. Such setting of the duty ratio command values dp1, dp2, dv1, and dv2 aims to make the braking force based on the pressure increase by the pump 115 of the first system 110 substantially equal to the braking force based on the pressure increase by the pump 125 of the second system 120. After setting of these duty ratio command values dp1, dp2, dv1, and dv2, the operation of the motors for the pumps 115 and 125 and the operation of the solenoids of the MC cut solenoid valves 111 and 121 are controlled respectively with the duty ratio command values dp1 and dp2 and with the duty ratio command values dv1 and dv2 (step S210). The CPU then exits from the braking control routine of FIG. 4. In this state, the sum of the braking force based on the master cylinder pressure Pmc from the wheel cylinders 109a through 109d and the braking force based on the pressure increase by the pumps 115 and 125, that is, the sum of the operational braking force BFpmc and the pressure increase-based braking force BFpp, is transmitted to the front wheels 65a and 65b and to the rear wheels 65c and 65d.

When the abnormality detection flag Fab1 for the first system 110 is identified as 1 and the abnormality detection flag Fab2 for the second system 120 is identified as 0 at step S190, there is some abnormality in the pressurization process of the brake oil by the pump 115 in the first system 110. The pump 125 and the MC cut solenoid valve 121 have no abnormality in the second system 120. In this state, the pressure increase by pressurization of the brake oil by the pump 125 in the normal second system 120 is to be enhanced to compensate for the failed pressure increase, which is to be attained by pressurization of the brake oil by the pump 115 in the abnormal first system 110. In order to achieve this requirement, the CPU sets the duty ratio command value dp2 for the pump 125 and the duty ratio command value dv2 for the MC cut solenoid valve 121 in the normal second system 120 corresponding to the pressure increase-based braking force BFpp, while setting 0 to the duty ratio command value dp1 for the pump 115 and the duty ratio command value dv1 for the MC cut solenoid valve 111 in the abnormal first system 110 (step S220). According to the concrete procedure of the embodiment, the duty ratio command value dp2 for the pump 125 and the duty ratio command value dv2 for the MC cut solenoid valve 121 are read corresponding to the pressure increase-based braking force BFpp set at step S170 respectively from the pump command value setting map and from the valve command value setting map. After setting of these duty ratio command values dp1, dp2, dv1, and dv2, the operation of the motor for only the pump 125 and the operation of the solenoid of only the MC cut solenoid valve 121 in the second system 120 are controlled respectively with the duty ratio command value dp2 and with the duty ratio command value dv2 (step S210). The CPU then exits from the braking control routine of FIG. 4. In this state, the braking force based on the master cylinder pressure Pmc from the wheel cylinders 109a and 109d is transmitted to the front wheel 65a and the rear wheel 65d corresponding to the first system 110. The sum of the braking force based on the master cylinder pressure Pmc from the wheel cylinders 109b and 109c and the braking force based on the pressure increase by the pump 125 is transmitted to the front wheel 65b and the rear wheel 65c corresponding to the second system 120.

When the abnormality detection flag Fab1 for the first system 110 is identified as 0 and the abnormality detection flag Fab2 for the second system 120 is identified as 1 at step S190, there is some abnormality in the pressurization process of the brake oil by the pump 125 in the second system 120. The pump 115 and the MC cut solenoid valve 111 have no abnormality in the first system 110. In this state, the pressure increase by pressurization of the brake oil by the pump 115 in the normal first system 110 is to be enhanced to compensate for the failed pressure increase, which is to be attained by pressurization of the brake oil by the pump 125 in the abnormal second system 120. In order to achieve this requirement, the CPU sets the duty ratio command value dp1 for the pump 115 and the duty ratio command value dv1 for the MC cut solenoid valve 111 in the normal first system 110 corresponding to the pressure increase-based braking force BFpp, while setting 0 to the duty ratio command value dp2 for the pump 125 and the duty ratio command value dv2 for the MC cut solenoid valve 121 in the abnormal second system 120 (step S230). According to the concrete procedure of the embodiment, the duty ratio command value dp1 for the pump 115 and the duty ratio command value dv1 for the MC cut solenoid valve 111 are read corresponding to the pressure increase-based braking force BFpp set at step S170 respectively from the pump command value setting map and from the valve command value setting map. After setting of these duty ratio command values dp1, dp2, dv1, and dv2, the operation of the motor for only the pump 115 and the operation of the solenoid of only the MC cut solenoid valve 111 in the first system 110 are controlled respectively with the duty ratio command value dp1 and with the duty ratio command value dv1 (step S210). The CPU then exits from the braking control routine of FIG. 4. In this state, the sum of the braking force based on the master cylinder pressure Pmc from the wheel cylinders 109a and 109d and the braking force based on the pressure increase by the pump 115 is transmitted to the front wheel 65a and the rear wheel 65d corresponding to the first system 110. The braking force based on the master cylinder pressure Pmc from the wheel cylinders 109b and 109c is transmitted to the front wheel 65b and the rear wheel 65c corresponding to the second system 120.

When both the abnormality detection flags Fab1 and Fab2 are identified as 1 at step S180, there is some abnormality both in the pressurization process of the brake oil by the pump 115 in the first system 110 and in the pressurization process of the brake oil by the pump 125 in the second system 120. In this state, the CPU immediately exits from the braking control routine of FIG. 4 without setting the duty ratio command values dp1 and dp2 for the pumps 115 and 125 and the duty ratio command values dv1 and dv2 for the MC cut solenoid valves 111 and 121, that is, without pressurization of the brake oil in the first system 110 and in the second system 120. The non-pressurization of the brake oil by the pumps 115 and 125 causes an insufficiency to the required braking force. The operational braking force BFpmc is increased by the driver's further depression of the brake pedal 85 to the greater depth to compensate for the insufficiency.

In the hybrid vehicle 20 of the embodiment described above, the braking force demand BF* required by the driver is satisfied by the sum of the operational braking force BFpmc based on the master cylinder pressure Pmc and the braking force BFpp based on the pressure increase by the pumps 115 and 125. When both the first system 110 and the second system 120 of the brake actuator 102 are normal and enable the required pressurization of the brake oil, the operation of the brake actuator 102 included in the HBS 100 is controlled to attain pressurization of the brake oil by the pumps 115 and 125 in the first and the second systems 110 and 120 and satisfy the braking force demand BF* required by the driver (steps S200 and S210). When there is some abnormality in either of the first system 110 and the second system 120, the operation of the brake actuator 102 included in the HBS 100 is controlled to enhance the pressure increase by the pump in the normal braking system (the first system 110 or the second system 120) to a certain extent for compensating for a pressure increase expected to be attained by the pump in the abnormal braking system (the second system 120 or the first system 110) (step S220 or S230 and step S210). Such operation control attains pressurization of the brake oil by the pump in the normal braking system, that is, either by the pump 115 in the normal first braking system or by the pump 125 in the normal second braking system, and satisfies the braking force demand BF* required by the driver. The braking force demand BF* required by the driver is expected to be satisfied by the sum of the operational braking force BFpmc based on the master cylinder pressure Pmc and the braking force BFpp based on the pressure increase by the pumps 115 and 125. Namely the braking force based on the pressure increase by the pumps 115 and 125 is utilized to compensate for an insufficiency of the sum of the operational braking force BFpmc based on the master cylinder pressure Pmc and the regenerative braking force of the motor 50. There may be, however, some abnormality either in the pressurization process of the brake oil by the pump 115 in the first system 110 or in pressurization process of the brake oil by the pump 125 in the second system 120. Even in the event of such abnormality, the braking control executed in the hybrid vehicle 20 of the embodiment ensures satisfaction of the braking force demand required by the driver. The braking control of the embodiment sets the duty ratio command values dp1 and dp2 for the pumps 115 and 125 and the duty ratio command values dv1 and dv2 for the MC cut solenoid valves 111 and 121, based on the pressure increase-based braking force BFpp set at step S170 and the abnormality detection flags Fab1 and Fab2 set in the abnormality detection routine of FIG. 3 (step S200, S220, or S230). The pressure increase-based braking force BFpp is the result of subtraction of the effective regenerative braking force BFr and the master cylinder pressure Pmc-based operational braking force BFpmc from the braking force demand BF* required by the driver. This arrangement enables the adequate setting of the respective duty ratio command values dp1, dp2, dv1, and dv2.

The abnormality detection routine shown in the flowchart of FIG. 3 may be replaced by any abnormality detection routine that is executed to detect a failure or abnormality in at least any of a pump and an MC cut solenoid valve provided in each of multiple braking systems included in a brake actuator. The abnormality detection is performed immediately after the ON operation of the ignition switch 80 in the above embodiment. But this is neither essential nor restrictive, and the abnormality detection may be performed during a drive of the hybrid vehicle 20, for example, during braking operation, during ABS (antilock brake system) control, during TRC (traction control), or during VSC (vehicle system control). In the structure of the above embodiment, the brake actuator 102 of the HBS 100 has the first system 110 and the second system 120 in the cross arrangement. This arrangement of the braking systems is, however, not restrictive. The brake actuator may have multiple braking systems in any adequate arrangement other than the cross arrangement, for example, in an anterior-posterior arrangement. In the brake actuator having an anterior braking system and a posterior braking system, the braking control routine of FIG. 4 distributes the pressure increase-based braking force BFpp into the two braking systems according to a predetermined anterior-posterior distribution ratio and sets duty ratio commands values for pumps and MC cut solenoid valves. The brake actuator of the HBS may include an accumulator or pressure reservoir. The technique of the invention is also applicable to a hydraulic braking system equipped with a brake actuator having three or more braking systems.

In the hybrid vehicle 20 of the embodiment, the power of the engine 22 is transmitted to the front wheels 65a and 65b via the output shaft 42 or the driveshaft. The power of the engine 22 may alternatively be transmitted to the rear wheels 65c and 65d via the rear axle 66. The power of the engine 22 may be connected to a generator, instead of transmission to the front wheels 65a and 65b or to the rear wheels 65c and 65d. In this modified structure, the motor 50 may be driven with electric power generated by the generator or with electric power generated by the generator and accumulated in a battery. Namely the technique of the invention is also applicable to series hybrid vehicles. In the hybrid vehicle 20 of the embodiment, the power of the motor 50 is transmitted to the rear wheels 65c and 65d via the rear axle 66. The power of the motor 50 may alternatively be transmitted to the front wheels 65a and 65b. The belt-driven CVT 40 may be replaced by a toroidal CVT or a step transmission.

The embodiment discussed above is to be considered in all aspects as illustrative and not restrictive. There may be many modifications, changes, and alterations without departing from the scope or spirit of the main characteristics of the present invention. The scope and spirit of the present invention are indicated by the appended claims, rather than by the foregoing description.

The technique of the invention is preferably applied to automobile industries and relevant industries.

The disclosure of Japanese Patent Application No. 2006-141619 filed May 22, 2006 including specification, drawings and claims is incorporated herein by reference in its entirety.

What is claimed is:

1. A vehicle having multiple wheels, the vehicle comprising:
a fluid pressure braking structure including multiple braking systems, the multiple braking systems respectively having a pressurization unit for pressurization of an operation fluid and being related to specified wheels among the multiple wheels, the fluid pressure braking structure capable of making the multiple braking systems output a braking force by utilizing an operational pressure of the operation fluid produced by a driver's braking operation and a pressure increase induced by pressurization of the operation fluid by the respective pressurization units;
an abnormality detection module that detects an abnormality in any of the multiple braking systems, the abnormality causing failed pressurization of the operation fluid by the pressurization unit; and
a braking control module that controls the fluid pressure braking structure to enable pressurization of the operation fluid by the respective pressurization units of the multiple braking systems and to ensure satisfaction of a braking force demand required by the driver's braking operation in the case of detection of no abnormality in the multiple braking systems by the abnormality detection module when ensuring the braking force demand by utilizing the operational pressure and the pressure increase by the pressurization units, the braking control module controlling the fluid pressure braking structure to enable pressurization of the operation fluid by the pressurization unit of only a normal braking system among the multiple braking systems and to ensure satisfaction of the braking force demand in the case of detection of an abnormality in any of the multiple braking systems by the abnormality detection module when ensuring the braking force demand by utilizing the operational pressure and the pressure increase by the pressurization units.

2. The vehicle in accordance with claim 1, wherein the braking control module controls the fluid pressure braking structure to enhance the pressure increase by the pressurization unit of the normal braking system to a certain extent for compensating for a pressure increase expected to be attained by the pressurization unit of an abnormal braking system and to ensure satisfaction of the braking force demand in the case of detection of an abnormality in any of the multiple braking systems when ensuring the braking force demand by utilizing the operational pressure and the pressure increase by the pressurization units.

3. The vehicle in accordance with claim 1, the vehicle further comprising:
a motor that is driven to output at least a regenerative braking force;
an accumulator unit that inputs and outputs electric power from and to the motor;
a braking force demand setting module that sets a braking force demand required by the driver in response to the driver's braking operation; and
a pressurization command value setting module that sets a pressurization command value for the pressurization unit of each normal braking system based on the set braking force demand, the regenerative braking force output from the motor, an operational braking force based on the operational pressure, and a result of the abnormality detection by the abnormality detection module,
wherein the braking control module controls the motor and the fluid pressure braking structure to actuate the pressurization unit of each normal braking system with the set pressurization command value and to ensure satisfaction of the set braking force demand.

4. The vehicle in accordance with claim 3, the vehicle further comprising:
an operational pressure measurement unit that measures the operational pressure of the operation fluid produced by the driver's braking operation; and
a regenerative braking force setting module that sets a regenerative braking force generated by regeneration of the motor in response to the driver's braking operation,
wherein the pressurization command value setting module sets the pressurization command value for the pressurization unit of each normal braking system based on a result of subtraction of the set regenerative braking force and an operational braking force based on the measured operational pressure from the set braking force demand, as well as based on the result of the abnormality detection by the abnormality detection module.

5. The vehicle in accordance with claim 4, wherein the regenerative braking force setting module sets the regenerative braking force generated by regeneration of the motor in response to the driver's braking operation based on a rotation speed of the motor and a state of charge of the accumulator unit.

6. The vehicle in accordance with claim 1, the vehicle further comprising:
an operational pressure generation unit that pressurizes the operation fluid in response to the driver's braking operation and thereby generates the operational pressure,
wherein the pressurization unit included in each of the multiple braking systems has a pump that is actuated to apply an additional pressure to the operation fluid fed from the operational pressure generation unit, and a pressure difference adjustment unit that functions to adjust a pressure difference between inlet and an outlet of the pump, and wherein the abnormality detection module detects an abnormality in at least either of the pump and the pressure difference adjustment unit in each of the multiple braking systems.

7. A control method of a vehicle, the vehicle having: multiple wheels; and a fluid pressure braking structure including multiple braking systems, the multiple braking systems respectively having a pressurization unit for pressurization of an operation fluid and being related to specified wheels among the multiple wheels, the fluid pressure braking structure capable of making the multiple braking systems output a braking force by utilizing an operational pressure of the operation fluid produced by a driver's braking operation and a pressure increase induced by pressurization of the operation fluid by the respective pressurization units, the control method comprising the steps of:
(a) detecting an abnormality in any of the multiple braking systems, the abnormality causes failed pressurization of the operation fluid by the pressurization unit; and
(b) controlling the fluid pressure braking structure to enable pressurization of the operation fluid by the respective pressurization units of the multiple braking systems and to ensure satisfaction of a braking force demand required by the driver's braking operation in the case of detection of no abnormality in the multiple braking systems in the step (a) when ensuring the braking force demand by utilizing the operational pressure and the pressure increase by the pressurization units, and controlling the fluid pressure braking structure to enable pressurization of the operation fluid by the pressurization unit of only a normal braking system among the multiple braking systems and to ensure satisfaction of the braking force demand in the case of detection of an abnormality in any of the multiple braking systems in the step (a) when ensuring the braking force demand by utilizing the operational pressure and the pressure increase by the pressurization units.

8. The control method in accordance with claim 7, wherein the step (b) controls the fluid pressure braking structure to enhance the pressure increase by the pressurization unit of the normal braking system to a certain extent for compensating for a pressure increase expected to be attained by the pressurization unit of an abnormal braking system and to ensure satisfaction of the braking force demand in the case of detection of an abnormality in any of the multiple braking systems when ensuring the braking force demand by utilizing the operational pressure and the pressure increase by the pressurization units.

9. The control method in accordance with claim 7, wherein the vehicle further includes: a motor that is driven to output at least a regenerative braking force; and an accumulator unit that inputs and outputs electric power from and to the motor, the control method further comprising the step of:
(c) setting a pressurization command value for the pressurization unit of each normal braking system based on the braking force demand, the regenerative braking force output from the motor, an operational braking force based on the operational pressure, and a result of the abnormality detection in the step (a),
wherein the step (b) controls the motor and the fluid pressure braking structure to actuate the pressurization unit of each normal braking system with the pressurization command value set in the step (c) and to ensure satisfaction of the braking force demand.

10. The control method in accordance with claim 9, wherein the vehicle further includes: an operational pressure measurement unit that measures the operational pressure of the operation fluid produced by the driver's braking operation, the control method further comprising the step of:
(d) setting a regenerative braking force generated by regeneration of the motor in response to the driver's braking operation,
the step (c) setting the pressurization command value for the pressurization unit of each normal braking system based on a result of subtraction of the regenerative braking force set in the step (d) and an operational braking force based on the measured operational pressure from the braking force demand, as well as based on the result of the abnormality detection in the step (a).

11. The control method in accordance with claim 10, wherein the step (d) sets the regenerative braking force generated by regeneration of the motor, in response to the driver's braking operation based on a rotation speed of the motor and a state of charge of the accumulator unit.

12. The control method in accordance with claim 7, wherein the vehicle further includes: an operational pressure generation unit that pressurizes the operation fluid in response to the driver's braking operation and thereby generates the operational pressure, wherein the pressurization unit included in each of the multiple braking systems has a pump that is actuated to apply an additional pressure to the operation fluid fed from the operational pressure generation unit and a pressure difference adjustment unit that functions to adjust a pressure difference between inlet and an outlet of the pump, and wherein the step (a) detecting an abnormality in at least either of the pump and the pressure difference adjustment unit in each of the multiple braking systems.
